(19) United States
(12) Patent Application Publication
(10) Pub. No.: US 2022/0043687 A1
(43) Pub. Date: Feb. 10, 2022

(54) METHODS AND APPARATUS FOR SCALABLE MULTI-PRODUCER MULTI-CONSUMER QUEUES

(71) Applicant: Intel Corporation, Santa Clara, CA (US)

(72) Inventor: Jonas Svennebring, Sollentuna (SE)

(21) Appl. No.: 17/507,506

(22) Filed: Oct. 21, 2021

Related U.S. Application Data
(60) Provisional application No. 63/094,847, filed on Oct. 21, 2020.

(51) Int. Cl. G06F 9/50

(52) U.S. Cl. CPC G06F 9/5027; G06Q 20/1235

(57) ABSTRACT

Methods and apparatus are disclosed for scalable multi-producer multi-consumer queues. At least one non-transitory machine-readable medium comprises instructions that, when executed, cause a processor to enqueue a first value into a first element of a queue using an atomic operation, the first element identified by a producer index, update the producer index to identify a second element of the queue using an atomic operation, the second element determined by one or more of the producer index and a length of the queue, dequeue a second value from a third element of the queue using an atomic operation, the second element identified by a consumer index, and update the consumer index to identify a fourth element of the queue in the using an atomic operation, the fourth element determined by one or more of the consumer index and the length of the queue.

### RELATED APPLICATION

This patent claims priority to U.S. Provisional Patent Application Ser. No. 63/094,847, which was filed on Oct. 21, 2020. U.S. Provisional Patent Application No. 63/094,847 is hereby incorporated herein by reference in its entirety.

### FIELD OF THE DISCLOSURE

This disclosure relates generally to queues, and, more particularly, methods and apparatus for scalable multi-producer multi-consumer queues.

### BACKGROUND

Parallel computing allows for improved processing of tasks. In recent years, producer and consumer architectures have been utilized to allow for parallel computing. Such an architecture allows for distribution of a task requested by a producer, for performance by a consumer.

### BRIEF DESCRIPTION OF THE DRAWINGS

FIG. 1 is a block diagram of an example system for scalable multi-producer multi-consumer queues.

FIG. 2 is a block diagram of an example implementation of the atomic queue circuitry of FIG. 1.

FIG. 3 is a block diagram of an example implementation of the queue structure circuitry of FIG. 2.

FIG. 4 is a first illustrative example of the queue circuitry of FIG. 2.

FIG. 5 is a second illustrative example of the queue circuitry of FIG. 2.

FIG. 6 is a flowchart representative of machine-readable instructions which may be executed to implement the example initializer circuitry of FIG. 2.

FIG. 7 is a flowchart representative of machine-readable instructions which may be executed to set segment counters as described in FIG. 6.

FIG. 8 is a flowchart representative of machine-readable instructions which may be executed to set processes as described in FIG. 6.

FIG. 9 is a flowchart representative of machine-readable instructions which may be executed to implement the example enqueue circuitry of FIG. 2.

FIG. 10 is a flowchart representative of machine-readable instruction which may be executed to check a producer point location as described in FIG. 9.

FIG. 11 is a flowchart representative of machine-readable instruction which may be executed to attempt to open a segment as described in FIG. 9.

FIG. 12 is a flowchart representative of machine-readable instruction which may be executed to implement the example dequeue circuitry of FIG. 2.

FIG. 13 is a flowchart representative of machine-readable instruction which may be executed to read an entries array as described by FIG. 12.

FIG. 14 is a block diagram of an example processor platform structured to execute the instructions of FIGS. 6, 7, 8, 9, 10, 11, 12, and 13 to implement the atomic queue circuitry FIG. 1.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIGS. 6, 7, 8, 9, 10, 11, 12, and 13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Queues enable communication of data between two or more entities, such as between producer circuitry and consumer circuitry. The producer circuitry adds data to a queue by enqueueing at least one value. The consumer removes data from the queue by dequeuing at least one value. In some examples, the terms “enqueueing”, “adding”, or “inserting” a value into a queue may be used interchangeably. Similarly, the terms “dequeuing”, “subtracting”, or “removing” a value from a queue may be used interchangeably.

In some examples, queues are implemented using a shared memory object. Challenges may arise when multiple producer circuitry instances and multiple consumer circuitry instances update shared memory used in a queue. Such challenges may include, for example, collisions between more than one producers and/or consumers. A collision is when two or more entities update a single shared memory object simultaneously or contemporaneously, resulting in an error. The error may include missing or incorrect data.

Some previous solutions include approaches for avoiding collisions. For example, a lock may be used to protect a data structure. The lock limits updates to the data structure to one producer or one consumer at a time. As a result, this approach provides poor performance scaling as the number of producers and/or consumers increase. Other previous solutions, such as a Read-Copy-Update algorithm, attempt to reduce collisions without the use of a lock. However, these previous solutions provides different tradeoffs that limit usage such as, for example, relative high cost of writes, difficulty in hardware implementations, etc.

Example approaches disclosed herein seek to implement multi-producer multi-consumer queues that reduce or remove the usage of a lock. In doing so, multi-producer multi-consumer queues implemented according to the teachings of this disclosure exhibit improved performance scaling improved data structure flexibility over previous solutions. The example approaches disclosed herein utilize a circular queue capable of having one or more producers and/or consumers. In examples disclosed herein, the circular queue has a fixed array of elements. In some examples, the queue may be divided into a plurality of segments. Each segment of the plurality segments is closed to prevent dequeuing entries in the segment. Each entry in the queue has a ready flag to indicate whether the entry is ready to be dequeued. Each entry in the queue also has a dummy flag to indicate whether a node dequeuing data should discard the data within each entry. In some examples, the circular queue may be extended to cover multi-priority queues by duplicating the queue structure into different priority sub-queues. In some examples, multi-priority queues may be incorporated with vector arithmetic.

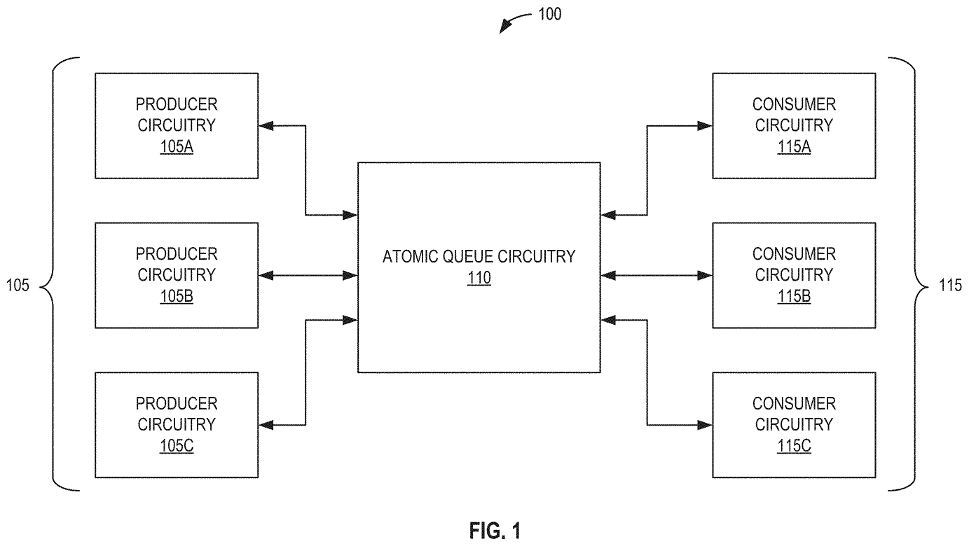

FIG. 1 is a block diagram of an example system for scalable multi-producer multi-consumer queues. The example system 100 includes example producer circuitry 105, example atomic queue circuitry 110, and example consumer circuitry 115.

The example producer circuitry 105 of FIG. 1 generates one or more values. In some examples, “generates” and other variations of the term may be referred to as “produces”. In some examples, the example producer circuitry 105 may be implemented by a software application, process, or thread. The value may describe any type or quantity of data. The example producer circuitry 105 attempts to store the one or more values in the example atomic queue circuitry.

In the example system 100, three example producer circuitry instances 105A, 105B, and 105C are shown for simplicity. In other examples, any number of example producer circuitry 105 instances may attempt to store values in the example atomic queue circuitry 110. A first value produced by an example producer circuitry instance 105A may be similar to, identical to, or different from a second value produced by the same instance 105A. Furthermore, the one or more values generated by an example producer circuitry instance 105A may be similar, identical, or different in comparison to the one or more values generated by a different example producer circuitry instance 105B. Any number of producer circuitry 105 instances may generate values for storage in the example atomic queue circuitry 110 simultaneously or concurrently.

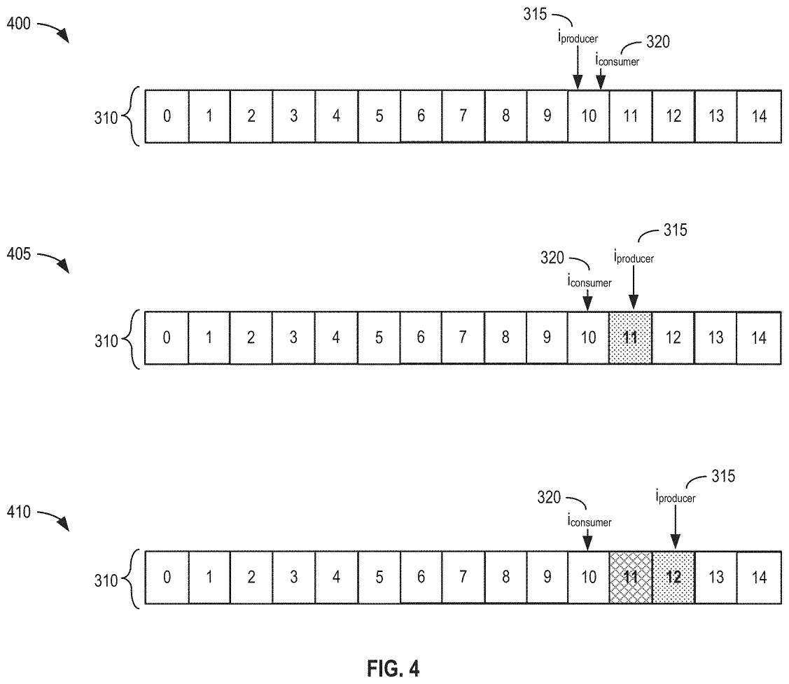

The example atomic queue circuitry 110 of FIG. 1 receives values from a source. The source may be an example producer circuitry 105 instance described previously. As used herein, values generated by the example producer circuitry 105 may be referred to as “real values”. The source may also be the example consumer circuitry 115. As used herein, values generated by the example consumer circuitry 115 may be referred to as “dummy values”. Dummy values are explored further in FIGS. 4, 9, and 12.

The example atomic queue circuitry 110 stores values in a circular queue. In the example atomic queue circuitry 110 of FIG. 1, values are enqueued and dequeued from the circular queue using a known First In First Out (FIFO) technique. FIFO is a technique that uses the order in which values are enqueued temporally to determine the order in which values are dequeued temporally. For example, the first value enqueued (First In) in an example FIFO queue is the first value dequeued (First Out), the second value enqueued in the example FIFO queue is the second value dequeued, etc. In some examples, the circular queue may additionally be extended to cover multi-priority queues by duplicating the circular queue structure into different priority sub-queues. In some such examples, values may be placed into a particular sub-queue based on an assigned priority of the values. In some such examples, multi-priority queues may be incorporated with vector arithmetic.

The example consumer circuitry 115 of FIG. 1 requests values from the example atomic queue circuitry 110. In some examples, the example consumer circuitry 115 may be implemented by a software application, process, or thread. In some examples, the example consumer circuitry 115 receives a real value from the example atomic queue circuitry 110. In some such examples, the example consumer circuitry 115 may perform a task using the value. In some examples, the performing of a task using the value is also referred to as consuming the value.

In the example system 100, three consumer circuitry instances 115A, 115B, 115C are shown for simplicity. In other examples, any number of consumer circuitry 115 instances may request values from the example atomic queue circuitry 110. Any number of consumer circuitry 115 instances may request values from the example atomic queue circuitry 110 simultaneously or concurrently.

In the example system 100, each instance of the example producer circuitry 105 and each instance of the example consumer circuitry 115 has a queue status flag. The queue status flag is updated by the example atomic queue circuitry 110 and indicates whether the circular queue was full at the time the flag was updated last. The queue status flag of an example producer circuitry 105 instance is updated when the producer instance attempts to enqueue a value, and the queue status flag of an example consumer circuitry 115 instance is updated when the consumer instance requests a value from the example atomic queue circuitry 110. The queue status flag is explored further in FIGS. 8, 9, 10, and 12.

The example atomic queue circuitry 110 enables multiple example producer circuitry 105 instances to generate values consumed by multiple example consumer circuitry 115 instances in a FIFO ordering. As the number example producer circuitry 105 instances and example consumer circuitry 115 instances increases, the probability of a collision increases. These increased collisions affect the ability for queues implemented using previous solutions to efficiently enqueue and dequeue values. In some examples, the ability for a queue to efficiently enqueue values from multiple producer circuitry 105 instances and efficiently dequeue values from multiple consumer circuitry 115 instances is referred to the queue's scalability. By utilizing the teachings of this disclosure, the example atomic queue circuitry 110 improves upon the scalability of previous solutions.

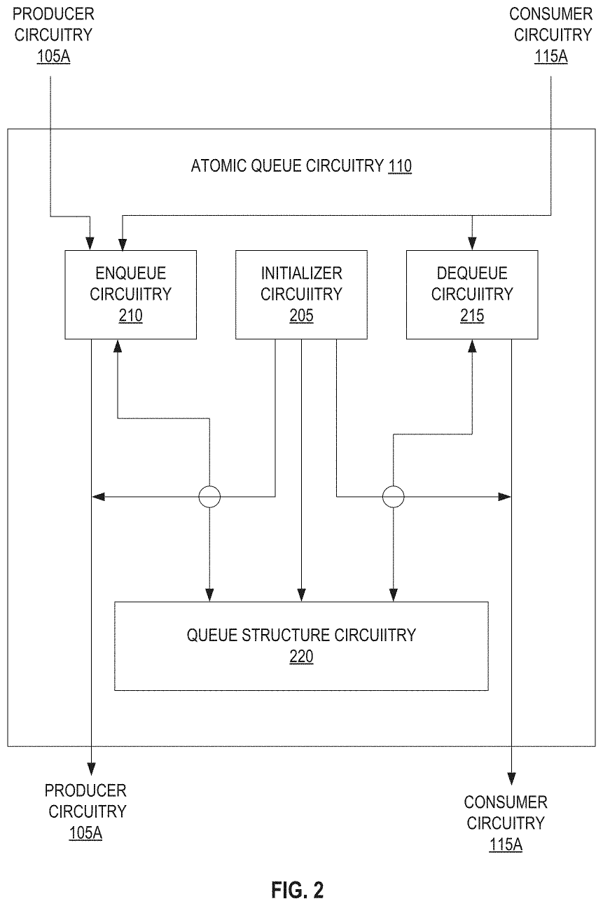

FIG. 2 is a block diagram of an example implementation of the atomic queue circuitry of FIG. 1. The example atomic queue circuitry 110 includes example initializer circuitry 205, example enqueue circuitry 210, example dequeue circuitry 215, and example queue structure circuitry 220.

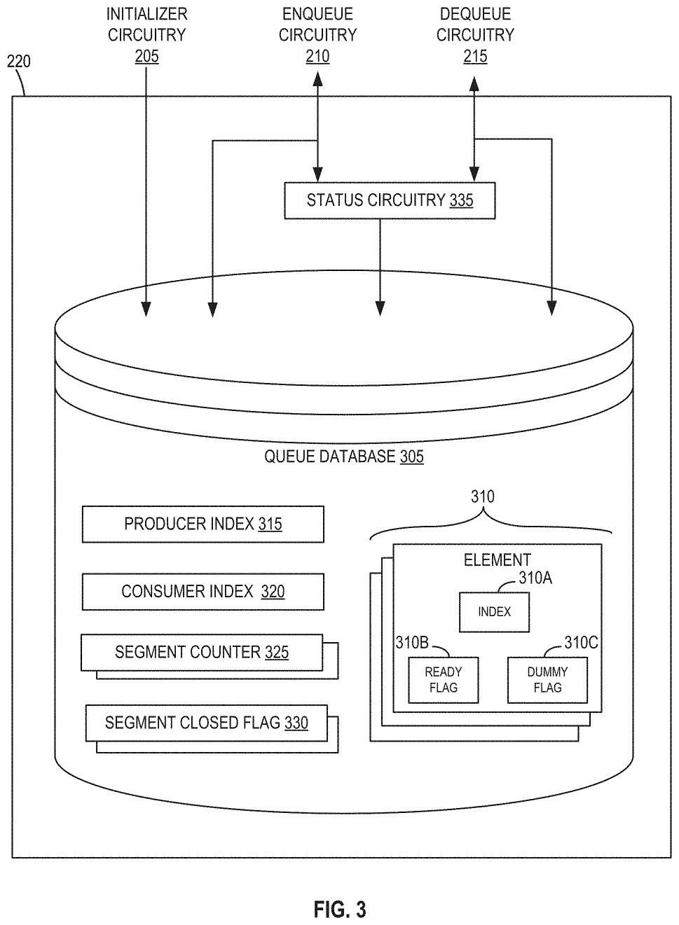

The example initializer circuitry 205 of FIG. 2 prepares the example queue structure circuitry 220 to begin processing requests to enqueue and dequeue values. The example queue structure circuitry 220 is explored further in FIG. 3.

The example initializer circuitry 205 also sets the queue status flags of the example producer circuitry 105 and the queue status flags of the example consumer circuitry 115 to indicate that the circular queue is not full. After the queue status flags are set by the initializer circuitry, the example producer circuitry 105 may attempt to enqueue values into the circular queue and the example consumer circuitry 115 may request values at any time.

The example enqueue circuitry 210 of FIG. 2 receives a request to enqueue a real value from the example producer circuitry instance 105A. In some examples, the example enqueue circuitry 210 receives a request to enqueue a dummy value from the example consumer circuitry instance 115A.

When a producer circuitry instance 105A attempts to enqueue a first value, the example enqueue circuitry 210 may access the first value and access the queue structure circuitry 220 in a first process executed by a processing unit. Similarly, when a different consumer circuitry instance 115B attempts to enqueue a second value, a second process executed by a processing unit may enable the enqueue circuitry to receive the second value and access the queue structure circuitry 220. The separate processes generated by the plurality of producer circuitry 105 instances may be executed independently of one another.

In some examples, the example enqueue circuitry 210 adds the received value to the circular queue using an atomic operation. An atomic operation is an operation applied by a first computer process or thread that is unable to be read or changed by a second computer process or thread until the operation is complete. Therefore, if atomic operations are used to enqueue a first value into the circular queue, a second value is unable to enter the circular queue until the atomic operation of the first value is complete and the circular queue is updated. Similarly, when the example dequeue circuitry 215 dequeues a first value from the circular queue for a first consumer circuitry instance 115A, a second consumer circuitry instance 115B is unable to receive a second value until the removal of the first value is complete and the circular queue is updated.

The example enqueue circuitry 210 and example dequeue circuitry 215 use atomic functions to avoid collisions. Examples of atomic functions used by the example enqueue circuitry 210 and example dequeue circuitry 215 include but are not limited to atomic addition (ADD), atomic subtraction (SUB), atomic increment (INC), atomic decrement (DEC). In some examples, an atomic exchange function returns the value in the shared memory of an element before updating the shared memory and changing the value. The atomic exchange function may be symbolized by an additional capital X. Therefore, additional examples of atomic functions used by the example enqueue circuitry 210 and example dequeue circuitry 215 include but are not limited to atomic addition (XADD), atomic subtraction (XSUB), atomic increment (XINC), atomic decrement (XDEC).

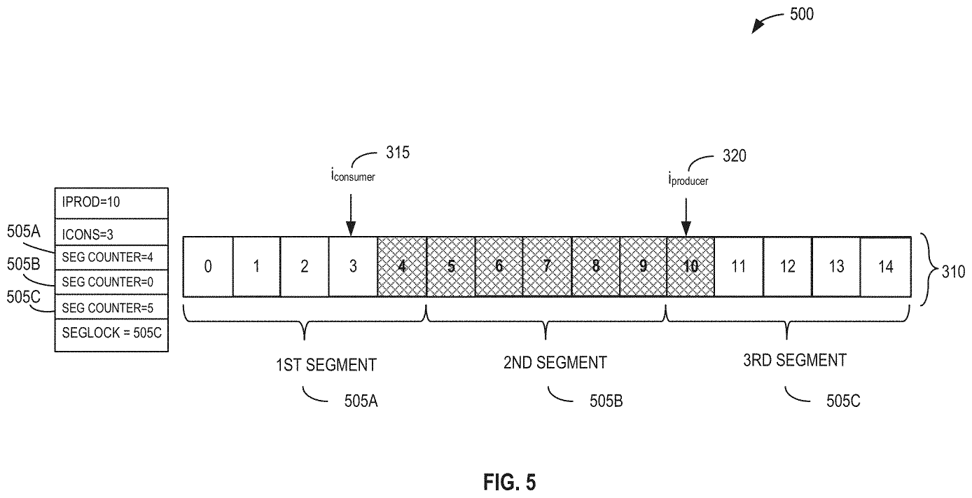

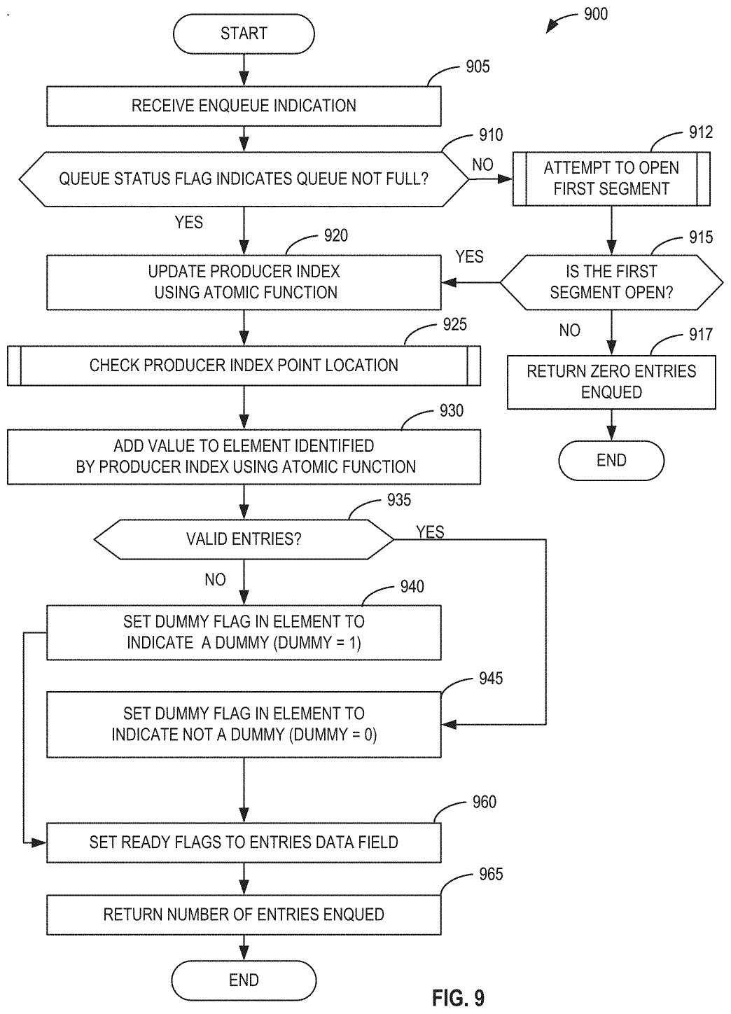

In some examples, the example enqueue circuitry 210 sets the queue status flag of the received value's source to indicate that circular queue is full. The example enqueue circuitry 210 is explored further in FIGS. 5, 9.

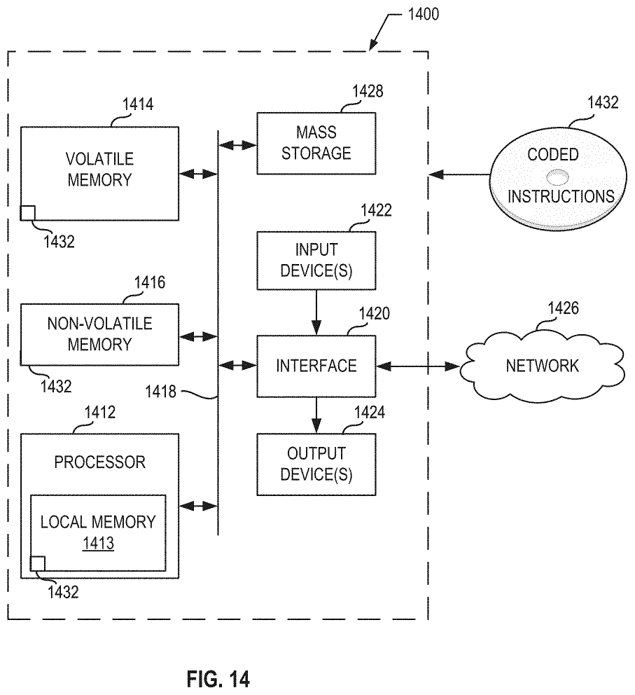

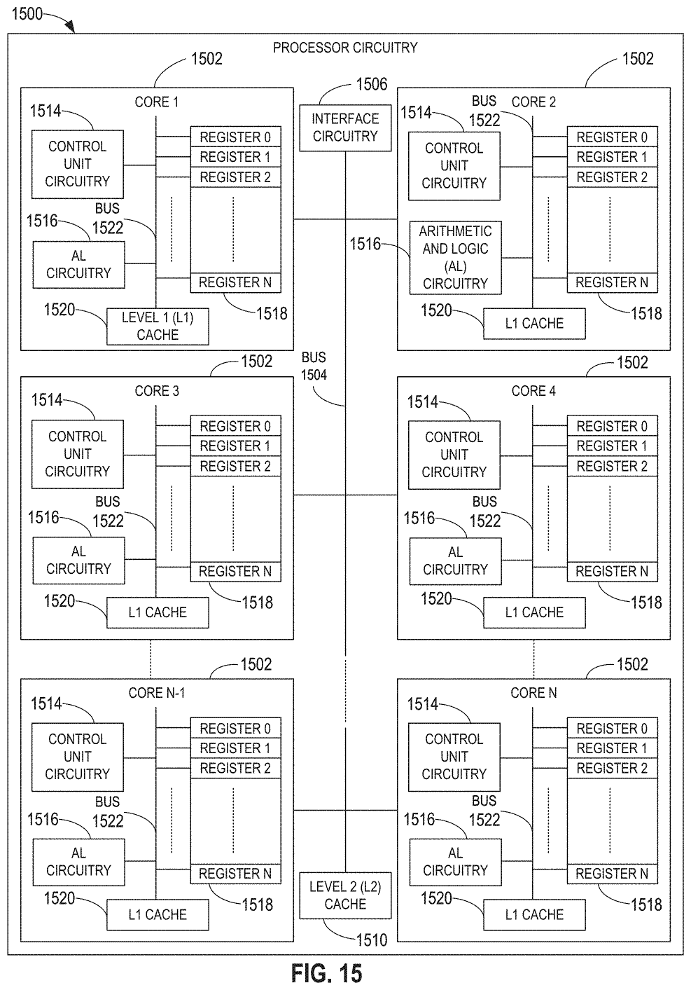

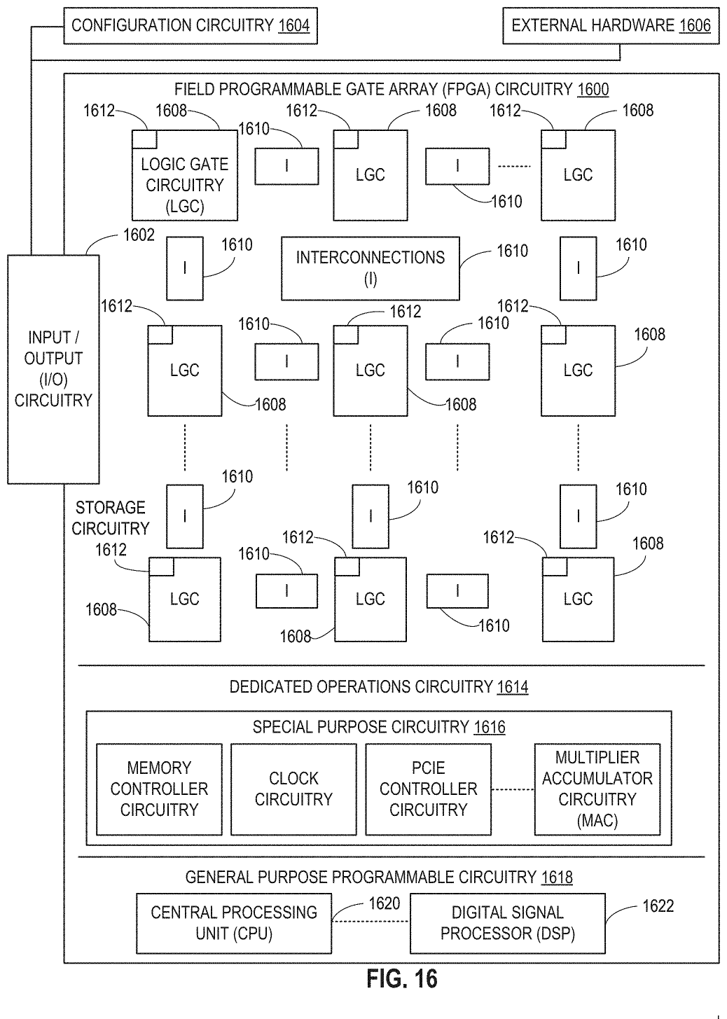

In some examples, the atomic queue circuitry 110 includes means for enqueuing. For example, the means enqueuing may be implemented by enqueue circuitry 210. In some examples, the enqueue circuitry 210 may be implemented by machine executable instructions such as that implemented by at least blocks 905-965 of FIG. 9 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the enqueue circuitry 210 is implemented by other hardware logic circuitry, hardware implemented state machines, and/or any other combination of hardware, software, and/or firmware. For example, the enqueue circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

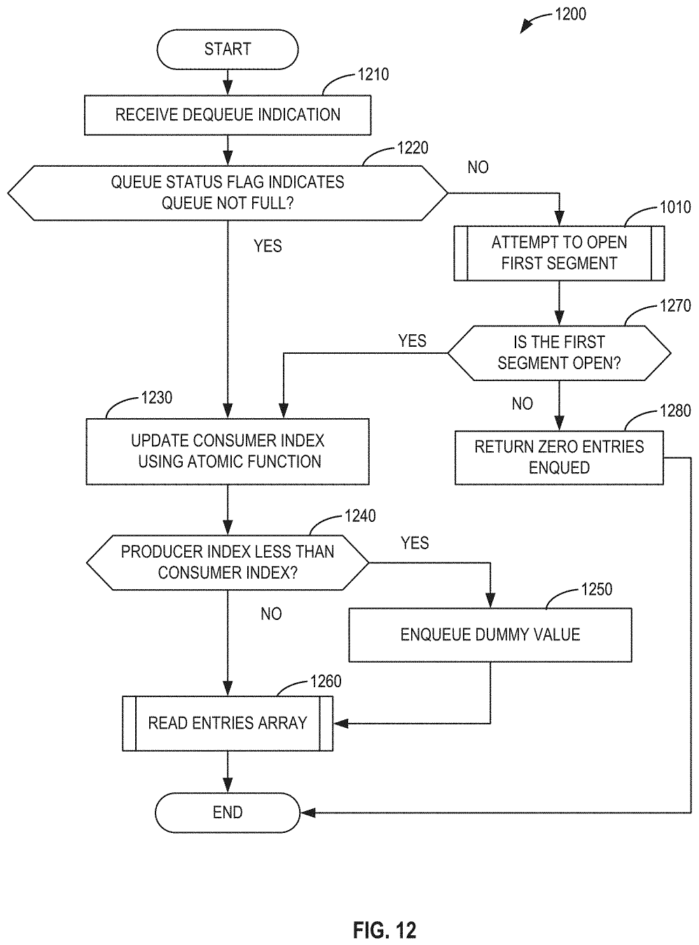

The example dequeue circuitry 215 of FIG. 2 receives a requests for a value from the example consumer circuitry instance 115A. The example dequeue circuitry 215 dequeues the value from the circular queue using an atomic function as described previously. The example dequeue circuitry 215 provides the removed value to the example consumer circuitry instance 115A. In some examples, the example dequeue circuitry 215 may also determine that the circular queue is empty. The example dequeue circuitry 215 is explored further in FIGS. 4, 12.

When a consumer circuitry instance 115A requests a first value, the example dequeue circuitry 215 may access the request and access the queue structure circuitry 220 in a first process executed by a processing unit. Similarly, when a different consumer circuitry instance 115B requests a second value, a second process executed by a processing unit may enable the example dequeue circuitry 215 to receive the second value and access the queue structure circuitry 220. The separate processes generated by the plurality of consumer circuitry 115 instances may be executed independently of one another.

In some examples, the atomic queue circuitry 110 includes means for dequeuing. For example, the means for dequeuing may be implemented by example dequeue circuitry 215. In some examples, the example dequeue circuitry 215 may be implemented by machine executable instructions such as that implemented by at least blocks 1210-1260 of FIG. 12 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the dequeue circuitry 215 is implemented by other hardware logic circuitry, hardware implemented state machines, and/or any other combination of hardware, software, and/or firmware. For example, the dequeue circuitry 215 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the example atomic queue circuitry 110 of FIGS. 1 and 2, a given example producer circuitry 105 instance may attempt to enqueue one value at a time. Similarly, and a given a given example consumer circuitry 115 instance may request one value at a time. In some examples, an example producer circuitry 105 instance or an example consumer circuitry 115 instance may attempt to enqueue or dequeue more than one value at a time.

In the example block diagram of FIG. 2, only the example producer circuitry instance 105A and the example consumer circuitry instance 115A are illustrated in communication with the example atomic queue circuitry 110 for simplicity. In practice, any number of example producer circuitry 105 instances and any number of example consumer circuitry 115 instances may communicate with the example atomic queue circuitry 110 simultaneously or contemporaneously. Therefore, multiple sources may generate multiple values to be enqueued, and multiple example consumer circuitry 115 instances may request multiple values to be dequeued.

The example queue structure circuitry 220 of FIG. 2 contains the circular queue in which values are enqueued and dequeued. The example queue structure circuitry 220 also contains additional parameters and circuitry that support the enqueuing and dequeuing of values into and from the circular queue. The example queue structure circuitry 220 is explored further in FIG. 3.

The example atomic queue structure circuitry 110 of FIG. 2 includes a single circular queue. In some examples, the example atomic queue structure circuitry 110 includes multiple circular queues of different priorities. In some such examples, the example enqueue circuitry 210 determines whether to enqueue a value into a particular circular queue based on an assigned priority of the value.

In some examples, the atomic queue circuitry 110 includes means for determining whether to enqueue a value into a particular circular queue. For example, the means for determining may be implemented by enqueue circuitry 210. In some examples, the enqueue circuitry 210 may be implemented by machine executable instructions such as that implemented by at least blocks 905 of FIG. 9 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the initializer circuitry 205 is implemented by other hardware logic circuitry, hardware implemented state machines, and/or any other combination of hardware, software, and/or firmware. For example, the initializer circuitry 205 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

By using atomic functions to enqueue and dequeue values from the circular queue, the example atomic queue circuitry 110 avoids collisions between multiple example producer circuitry 105 instances and multiple example consumer circuitry 115 instances. This increased efficiency allows for increased scalability of the example atomic queue circuitry 110.

FIG. 3 is a block diagram of an example implementation of the queue structure circuitry of FIG. 2. The example queue structure circuitry 220 includes an example queue database 305, example elements 310, an example producer index 315, an example consumer index 320, an example segment counter 325, an example segment closed flag 330, and example status circuitry 335.

The example queue database 305 stores the example elements 310, the example producer index 315, the example consumer index 320, and the example segment counter 325. The example queue database 305 is implemented by any memory, storage device and/or storage disc for storing data such as, for example, flash memory, magnetic media, optical media, solid state memory, hard drive(s), thumb drive(s), etc. Furthermore, the data stored in the example queue database 305 may be in any data format such as, for example, binary data, comma delimited data, tab delimited data, structured query language (SQL) structures, etc. While, in the illustrated example, the example queue database 305 is illustrated as a single device, the example queue database 305 and/or any other data storage devices described herein may be implemented by any number and/or type(s) of memories.

The elements 310 of FIG. 3 compose the circular queue. As used herein, a given element in the elements 310 is defined to be a data structure that contains an index 310A, a ready flag 310B, and a dummy flag 310C. A given element in the elements 310 may also contain a value. The ready flag 310B of an example element indicates whether the example element is ready to receive a new value. An example element is ready to receive a new value when the data structure does not contain a previously enqueued value. Similarly, the example element is not ready to receive a value when the data structure does contain a previously enqueued value. The dummy flag 310C of the example element indicates whether the example element contains a dummy value.

The data structure of a given element is a shared memory object. As a result, each of the separate processes generated by the plurality of producer circuitry 105 instances and each the separate processes generated by the plurality of consumer circuitry 115 instances may have access to read, write, or generally access the elements 310.

As used herein, the example producer index 315 is defined to be a value that identifies the element in the circular queue where the most recent value was enqueued. Similarly, as used herein, the example consumer index 320 is defined to be a value that identifies the element in the circular queue where the most recent value was dequeued. When the example producer index 315 and example consumer index 320 identify the same element, the circular queue is empty. In some examples, the example producer index 315 and example consumer index 320 may be implemented as pointers.

The example elements 310 of FIG. 3 are divided into two or more segments. In some examples, the number of segments is based on the total number of values that all sources can add to the example atomic queue circuitry 110 in a single enqueue operation per source. The number of segments is explored further in FIG. 5.

Each of the two or more segments have an example segment counter 325 and a segment closed flag 330. The example segment counter 325 of an example segment describes the number of elements in the example segment that have been dequeued. The example segment counter 325 is incremented by the example dequeue circuitry 215 and is decremented by the example enqueue circuitry 210.

The example segment closed flag 330 indicates whether a segment is in an open or closed state. Segments are opened and closed to prevent new values from entering a full circular queue. This allows a previous value to be dequeued from an example element of a full circular queue before the shared memory of the example element is rewritten to store a new value. In the example queue structure circuitry 220, segments are closed using a mutex lock. A mutex lock is a mechanism that mutually excludes access to a shared memory object. In some examples, a different type of lock may be utilized. Different types of types of locks include but are not limited to semaphores. In other examples, segment opening and closing is not implemented using a lock.

The example queue structure circuitry of FIG. 3 avoids locks or utilizes locks less frequently than previous solutions that utilize locks, while also avoiding the limitations of previous solutions that do not use locks. In doing so, the example atomic queue circuitry 110 exhibits increased performance scaling and flexibility over previous solutions. The use of the example segment closed flags 330 is explored further in FIGS. 5, 6, and 10.

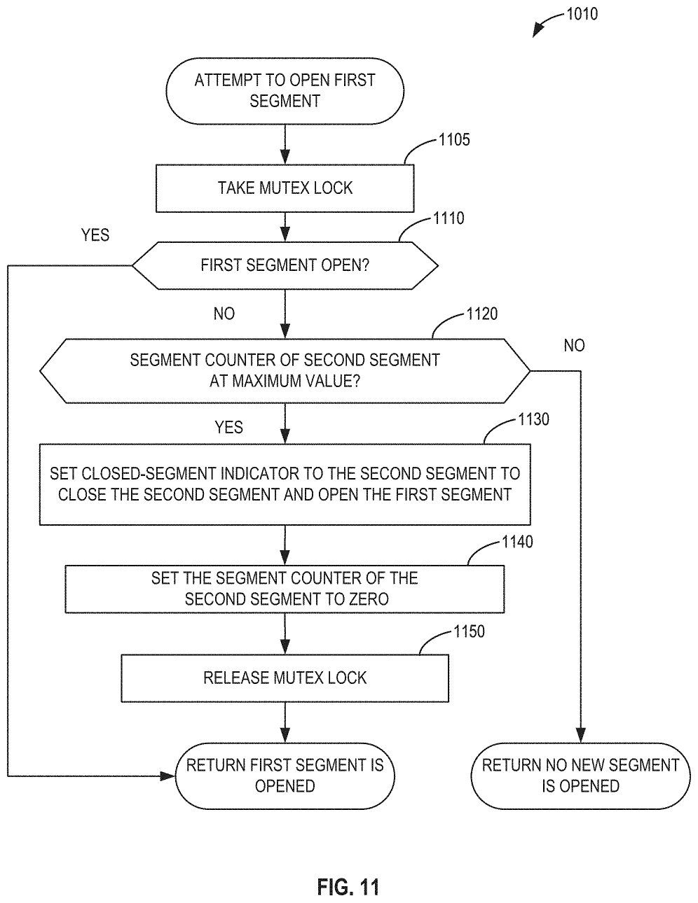

When an example producer circuitry instance 105 attempts to enqueue a value, the example status circuitry 335 of FIG. 3 may receive a request to open a segment from example enqueue circuitry 210. The process used to open a segment is explored further in FIG. 11. In response to a determination that a segment was opened, or if the queue status flag of the producer circuitry instance 105 indicates the queue is not full, the example enqueue circuitry 210 enqueues the example value into the circular queue.

Because the example dequeue circuitry 215 may only dequeue a value when the circular queue has at least one value, the example status circuitry 335 determines whether the producer index 315 and the consumer index 320 point to the same element. If the producer index 315 and the consumer index 320 do point to the same element, the circular queue is empty and the dequeue circuitry cannot dequeue an element. In response to a determination that the producer index 315 and the consumer index 320 do point to the same element, the example dequeue circuitry 215 enqueues a dummy value.

The example status circuitry 335 may also receive a request to open a segment when an example consumer circuitry 115 instance requests a value. In response to a determination that a segment was opened, or if the queue status flag of the producer circuitry instance 105 indicates the queue is not full, the example dequeue circuitry 215 dequeues a value from the circular queue. The dequeued value may be a real value or a dummy value. Real and dummy values are explored further in FIG. 4.

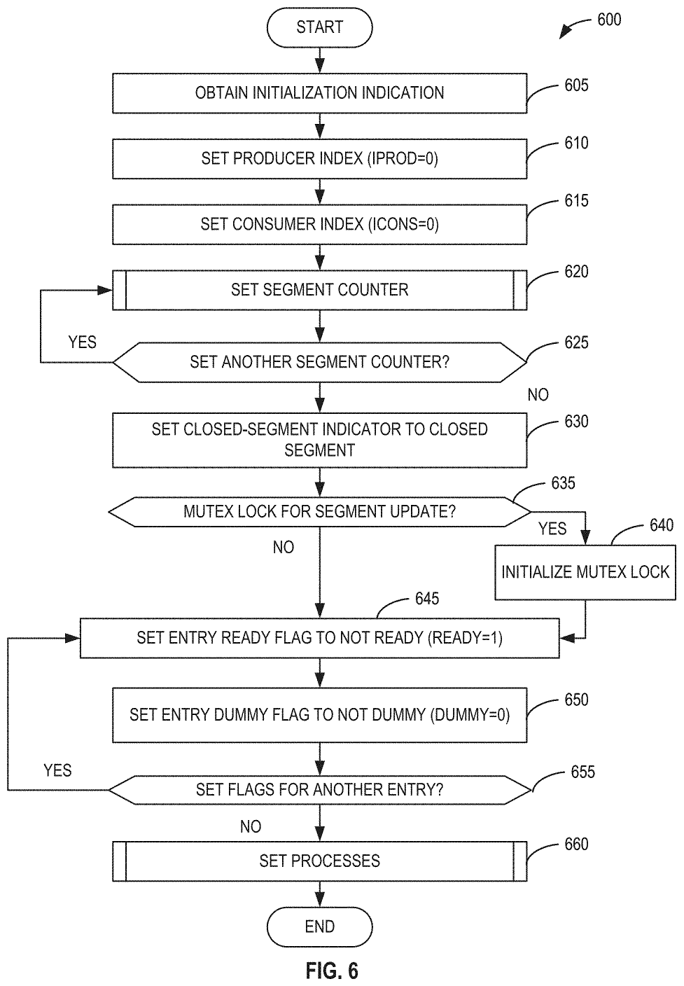

The example initializer circuitry 205 accesses the example queue database 305 to initialize the circular queue. The initialization includes setting the example producer index 315 and the example consumer index 320 to identify a starting element, setting the segment closed flags 330 to identify the appropriate segment, setting the ready flags 310B of the elements 310 to indicate they are ready to receive values, dividing the example elements 310 into two or more segments, and setting the dummy flag of the elements 310 to indicate there are no dummy entries at the time of initialization. The initializer circuitry is explored further in FIG. 6.

In some examples, the atomic queue circuitry 110 includes means for initializing a circular queue. For example, the means for initializing may be implemented by initializer circuitry 205. In some examples, the initializer circuitry 205 may be implemented by machine executable instructions such as that implemented by at least blocks 605-660 of FIG. 6 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the initializer circuitry 205 is implemented by other hardware logic circuitry, hardware implemented state machines, and/or any other combination of hardware, software, and/or firmware. For example, the initializer circuitry 205 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the initializer circuitry includes means for dividing elements into two or more segments. For example, the means for dividing may be implemented by initializer circuitry 205. In some examples, the initializer circuitry 205 may be implemented by machine executable instructions such as that implemented by at least blocks 620-625 of FIG. 6 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the initializer circuitry 205 is implemented by other hardware logic circuitry, hardware implemented state machines, and/or any other combination of hardware, software, and/or firmware. For example, the initializer circuitry 205 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The queue structure circuitry 220 enables values to be enqueued and dequeued using an atomic function. By doing so, the example atomic queue circuitry 110 exhibits increased scalability over previous solutions.

FIG. 4 is a first illustrative example of the queue circuitry of FIG. 2. FIG. 4 includes a first diagram 400, a second diagram 405, and a third diagram 410.

The first diagram 400, second diagram 405, and third diagram 410 show the example elements 310 that compose the circular queue. The index 310A of each element is illustrated as an integer inside the element. In the illustrative example of FIG. 4, the starting element in the elements 310 has an index 310A of the number 0. In some examples, the starting element has an index 310A of the number 1.

An example enqueue circuitry 210 enqueues a new value at the element identified by the producer index 315. After an enqueue, the producer index is updated to a “next” element. Suppose the element identified by the producer index 315 has an index 310A of x. In this example, the next element refers to the element with an index 310A of x+1, provided the number x+1 is greater than the index 310A of the last element in the circular queue. The last element in the circular queue is determined by the length, also referred to as the number of elements 310, of the circular queue. The example circular queue shown in the first diagram 400, second diagram 405, and third diagram 410 has a last element with an index 310A of 14.

When the number x+1 is greater than the index 310A of the last element in the circular queue, the next element instead refers to the first element of the circular queue, with index 310A of 0. Once at the element with index 310A of 0, the next element the producer index will identify after a next update is the element with index 310A of 1. Through this process, enqueues cause the producer index to identify the elements 310 in a circular fashion, thereby enabling the circular queue. Similarly, dequeues cause the consumer index to identify elements 310 in a circular fashion as described previously.

The first diagram of 400 shows an example circular queue after the dequeue circuitry removed a value from the element with index 310A of 10, thereby emptying the queue. The dequeue of the value results in the example consumer index 320 equaling the example producer index 315. As a result, a circular queue left in the state shown in the first diagram 400 may cause other consumer circuitry 115 instances to wait or idle until a new value is enqueued. In some examples, this idling may lead to decreased scalability of the example atomic queue circuitry 110.

The second diagram 405 of FIG. 4 shows the example circular queue in a first potential scenario following the dequeue of the first diagram 400. In response to a determination that the consumer index 320 is greater than the producer index 315, a first enqueue circuitry 210 process enqueues a dummy value into the next element, which has an index 310A of 11. A dummy value is a value that has no data and is discarded by a consumer circuitry 115 instance rather than consumed. By enqueuing a dummy value, the example atomic queue circuitry 110 prevents the circular queue from staying empty and the consumer circuitry 115 instances from idling.

The third diagram 410 shows a second potential scenario following the dequeue of the first diagram 400. Because a given consumer instance 115A operates independently of both a different consumer instance 115B and the producer circuitry 105 instances, the example atomic queue circuitry 110 may receive an attempt to enqueue a value or a request to dequeue a value at any time. In the third diagram 410, a second enqueue circuitry 210 process enqueues a value into the next element which has an index 310A of 11 after the determination that the circular queue is empty, but before the second enqueue circuitry 210 process enqueues a dummy element. Because enqueues and dequeues use atomic operations, the producer index is updated to point to the element with index 310A of 11 by the time the second enqueue circuitry 210 process begins, so the dummy element is added to the next element with index 310A of 12.

By enqueueing dummy values when the circular queue is empty, the example atomic queue circuitry 110 prevents the circular queue from staying empty and the consumer circuitry 115 instances from idling. Once the queue is empty, the next value provided to the a consumer circuitry instance 115A may be a dummy value as seen in the second diagram 405, or a real value as seen in the third diagram 410.

FIG. 5 is a second illustrative example of the queue circuitry of FIG. 2. The illustrative example 500 includes the example elements 310, the example producer index 315, the example consumer index 320, a first example segment 505A, a second example segment 505B, and a third example segment 505C.

The illustrative example 500 of FIG. 5 show the example elements 310 that compose the circular queue. The index 310A of each element is illustrated as an integer inside the element. The illustrative example 500 matches the illustrative example of FIG. 4, in that the first element in the elements 310 has an index 310A of the number 0 and the last element in the elements 310 has an index 310A of 14.

The example elements 310 in the illustrative example 500 are divided into a first example segment 505A, a second example segment 505B, and a third example segment 505C. The example segments are constructed so that a given element is assigned to one segment, so that elements with sequential indices are assigned to the same segment, and so that the number of elements in an example first segment 505A equals the number of elements in the example second segment 505B and example third segment 505C. In some examples, the number of elements 310 is not evenly divisible with the number of example segments. In some such examples, the number of elements in an example first segment may be similar but not equal to the number of elements in an example second segment.

In the illustrative example 500, the example segment closed flag 330 identifies a single segment in a closed state, while the remaining segments are in open state. At any point in time, the closed state is assigned to the segment preceding the current location of the consumer index. For example, in the illustrative example 500, the example consumer index 320 is on the element with index 310A of 3, which places the example consumer index 320 inside the first example segment 505A. Because the example consumer index 320 and the example producer index 315 traverse the elements 310 in a circular fashion, the preceding segment, which is also described as the previous segment where the consumer index 320 was located, is the third example segment 505C. Therefore, the third example segment 505C is closed in the illustrative example 500.

Because the example producer circuitry 105 instances and the example consumer circuitry 115 instances operate independently of one another, some circular queues may experience overflow. Overflow is when a example producer circuitry 105 instances fill the circular queue with more values than there are elements, causing the example producer index 315 to wrap around to identify the same element as the consumer index 320 and overwrite an old value with a new value before a consumer circuitry 115 instance can consume the old value. The illustrative example 500 prevents overflow by utilizing a example segment closed flags 330.

In the illustrated example 500, there are five examples producer circuitry 105 instances, and each instance may enqueue one value at a time. As a result, if each of the five examples producer circuitry 105 instances independently attempted to enqueue into the closed segment instance before the example consumer index 320 was updated, the producer index 315 would still identify an element in the closed segment and an overflow would be prevented. Therefore, the example status circuitry 335 limits an example producer circuitry 105 instance to one enqueue operation within a closed segment.

In some examples, the atomic queue circuitry 110 includes means for limiting a source to one enqueue within a closed segment. For example, the means for limiting may be implemented by status circuitry 335. In some examples, the status circuitry 335 may be implemented by machine executable instructions such as that implemented by at least block 1010 of FIG. 11 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the status circuitry 335 is implemented by other hardware logic circuitry, hardware implemented state machines, and/or any other combination of hardware, software, and/or firmware. For example, the status circuitry 335 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrative example 500, the example producer index identifies the element with index 310A of 10 because the example producer circuitry instance 105A enqueued a value into the closed segment. After the value was enqueued into the element with index 310A of 10, the example status circuitry 335 sets the queue status flag of the example producer circuitry instance 105A to indicate that the queue is full. As a result, the example producer circuitry instance 105A may not enqueue additional values until the example segment closed flags 330 change to indicate the example first segment 505A is closed. To change the example segment closed flags 330, example status circuitry 335 monitors the example segment counter value 325 of the example first segment 505A, which contains the example consumer index 320. When the segment counter value 325 equals the number of elements 310 in the example first segment 505A, then the example consumer index 320 no longer identifies an element in the example first segment 505A. As a result, the example status circuitry 335 switches the example segment closed flags 330 to indicate the example third segment 505C is in the open state and the example first segment 505A is in the closed state.

In some examples, the atomic queue circuitry 110 includes means for switching a segment between an opened state and a closed state. For example, the means for switching may be implemented by status circuitry 335. In some examples, the status circuitry 335 may be implemented by machine executable instructions such as that implemented by at least block 1010 of FIG. 11 executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the status circuitry 335 is implemented by other hardware logic circuitry, hardware implemented state machines, and/or any other combination of hardware, software, and/or firmware. For example, the status circuitry 335 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While the example producer circuitry instance 105A is unable to enqueue elements until the example segment closed flags 330 update, the remaining four producer circuitry instances 105B, 105C, 105D, 105E have their queue status flag set to indicate the queue is not full in the illustrative example 500. Therefore, each of the four producer circuitry instances 105B, 105C, 105D, 105E may enqueue an additional value before the segment closed flags 330 is moved to the first example segment 505A. Similarly, if the segment closed flags 330 is moved to the first example segment 505A before all five producer instances enqueue into the third example segment 505C, then the queue status flags are reset by the example status circuitry 335 and the example producer circuitry 105 instances are allowed to enqueue freely until the example producer index 315 identifies an element in the current closed segment.

The example segment closed flags 330 are updated by the example status circuitry 335. The status circuitry 335 runs in or is called by the dequeue circuitry 215 process that updated the example consumer index 320 out of one segment and into another segment, while other enqueue and dequeue processes remain unaffected by lock movement. As a result, the example atomic queue circuitry 110 reduces the reliance of locks in scalable queues when compared to previous solutions.

In some examples, the example queue structure circuitry 220 does not include a segment lock. In some such examples, the example atomic queue circuitry 110 may have a dedicated process to monitor the segments and determine when the circular queue is full. In some such examples, the example atomic queue circuitry 110 may assign segment monitoring and determination responsibilities to an example dequeue process that dequeues from the last element in a segment. In some such examples, the performance scaling of the example atomic queue circuitry 110 may be affected by avoiding a lock.

While an example manner of implementing the example atomic queue circuitry 110 of FIG. 1 is illustrated in FIG. 6, one or more of the elements, processes, and/or devices illustrated in FIG. 6 may be combined, divided, re-arranged, omitted, eliminated, and/or implemented in any other way. Further, the example initializer circuitry 205, the example enqueue circuitry 210, the example dequeue circuitry 215, the example queue structure circuitry 220, and/or, more generally, example atomic queue circuitry 110 of FIG. 1, may be implemented by hardware alone or by hardware in any combination with software and/or firmware. Thus, for example, any of the example initializer circuitry 205, the example enqueue circuitry 210, the example dequeue circuitry 215, the example queue structure circuitry 220, and/or, more generally, example atomic queue circuitry 110 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example atomic queue circuitry 110 of FIG. 1 may include one or more elements, processes, and/or devices in addition to, or instead of, those illustrated in FIG. 6, and/or may include more than one of any or all of the illustrated elements, processes and devices.

Flowcharts representative of example hardware logic circuitry, machine readable instructions, hardware implemented state machines, and/or any combination thereof for implementing the example atomic queue circuitry 110 of FIG. 1 are shown in FIGS. 6, 7, 8, 9, 10, 11, 12, and/or 13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6, 7, 8, 9, 10, 11, 12, and/or 13, many other methods of implementing the example atomic queue circuitry 110 of FIG. 1 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7, 8, 9, 10, 11, 12, and/or 13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

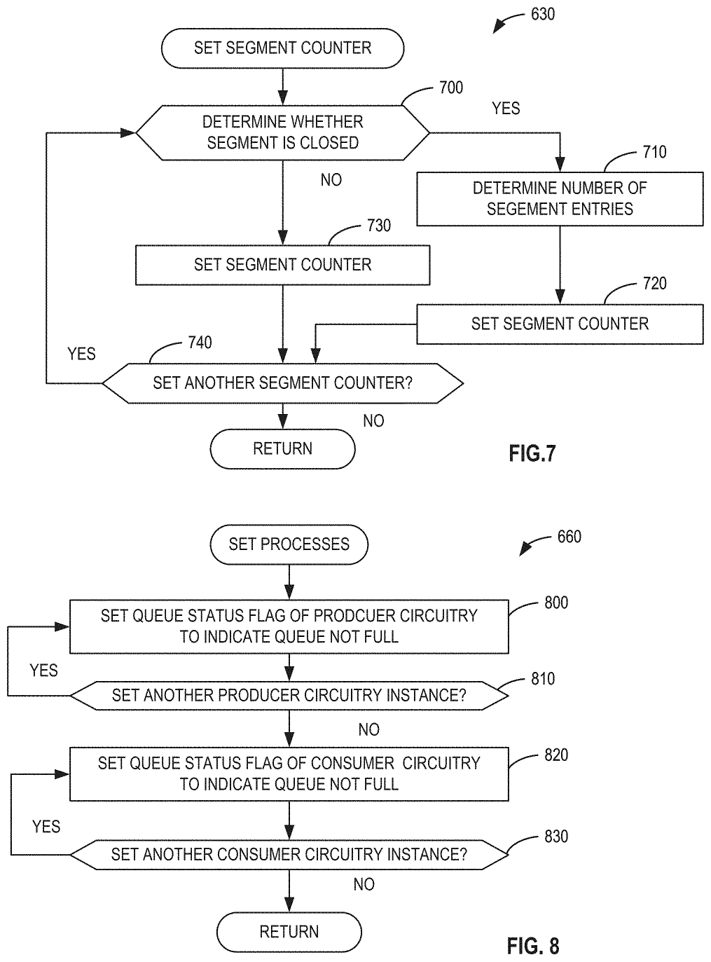

FIG. 6 is a flowchart representative of machine-readable instructions which may be executed to implement the example initializer circuitry of FIG. 2. The example program 200 of FIG. 2 begins when the example initializer circuitry 205 obtains an initialization indication. (Block 605). The example initializer circuitry 205 sets the producer index 315 to identify the first element of the queue (e.g., the element with index 310A of zero). (Block 610). The example initializer circuitry 205 sets consumer index 320 to identify the first element of the queue (e.g., the element with index 310A of zero). (Block 615). The example initializer circuitry 205 sets segment counters. (Block 620). An example approach to set segment counters that corresponds to the example implementation of the example initializer circuitry 205 is disclosed in further detail in connection with FIG. 7. The example initializer circuitry 205 determines whether there is another segment counter to set. (Block 625). If the example initializer circuitry 205 determines that there is another segment counter to set (e.g., Block 625 returns a result of YES), the example initializer circuitry 205 returns to Block 620 to set the segment counter for another segment counter.

If the example initializer circuitry 205 determines that there is not another segment counter to set (e.g., Block 625 returns a result of NO), the example initializer circuitry 205 sets a closed-segment indicator to a closed segment. (Block 630). The example initializer circuitry 205 determines whether the mutex lock is used for segment update. (Block 635). If the example initializer circuitry 205 determines that the mutex lock is not used for segment update (e.g., Block 635 returns a result of NO), the example initializer circuitry 205 sets the ready flag of the entry to indicate the entry is not ready. (Block 645). If the example initializer circuitry 205 determines that the mutex lock is used for segment update (e.g., Block 635 returns a result of YES), the example initializer circuitry 205 initializes mutex lock and continues to Block 645. (Block 640). The example initializer circuitry 205 sets the dummy flag of the entry to indicate the entry is a not a dummy entry. (Block 650). The example initializer circuitry 205 determines whether there is another entry that has ready flag and dummy flag to set (Block 655). If the example initializer circuitry 205 determines there is another entry that has ready flag and dummy flag to set (e.g., Block 655 returns a result of YES), the example initializer circuitry 205 returns to Block 645. If the example initializer circuitry 205 determines there is not another entry that has ready flag and dummy flag to set (e.g., Block 655 returns a result of NO), the example initializer circuitry 205 sets the queue status flags for the plurality of producer circuitry 105 instances and the plurality of consumer circuitry 115 instances (Block 660). An example approach to setting processes to correspond to the example implementation of the example initializer circuitry 205 is disclosed in further detail in connection with FIG. 8. The example process 600 of FIG. 6 terminates.

FIG. 7 is a flowchart representative of machine-readable instructions which may be executed to implement the example initializer circuitry 205 to set segment counters as described in FIG. 6. The example process 620 begins when the example initializer circuitry 205 determines whether the segment is closed (Block 700). If the example initializer circuitry 205 determines that the segment is closed (e.g., Block 700 returns a result of YES), the example initializer circuitry 205 determines the number of entries in the segment. (Block 710). The example initializer circuitry 205 sets the segment counter to the determined number of entries in the segment. (Block 720). The example initializer circuitry 205 determines whether there is another segment counter to set. (Block 740). If the example initializer circuitry 205 determines there is another segment counter to set. (e.g., Block 740 returns a result of YES), the example initializer circuitry 205 returns to Block 700. If the example initializer circuitry 205 determines there is not another segment counter to set, (e.g., Block 740 returns a result of NO), the example process 620 terminates and the example initializer circuitry 205 returns to Block 625.

If the example initializer circuitry 205 determines that the segment is not closed (e.g., Block 700 returns a result of NO), the example initializer circuitry 205 sets the segment counter to zero. (Block 730). The example initializer circuitry 205 continues to Block 740.

FIG. 8 is a flowchart representative of machine-readable instructions which may be executed to implement the example initializer circuitry 205 to set processes as described in FIG. 6. The example process 660 begins when the example initializer circuitry 205 sets the queue status flag to indicate the queue is not full for a example producer circuitry instance 105A. (Block 800). The example initializer circuitry 205 determines whether there is another queue status flag to set for the producer circuitry 105 instances. (Block 810). If the example initializer circuitry 205 determines there is another queue status flag to set for the producer circuitry 105 instances (e.g., Block 810 returns a result of YES), the example initializer circuitry 205 returns to Block 800 to set the flag of a different producer circuitry instance 105B.

If the example initializer circuitry 205 determines there is not another queue status flag to set for the producer circuitry 105 instances (e.g., Block 810 returns a result of NO), the example initializer circuitry 205 sets the queue status full flag to indicate the queue is not full for a consumer circuitry instance 115A. (Block 820). The example initializer circuitry 205 determines whether there is another queue status full flag to set for the consumer circuitry instances 115. (Block 830). If the example initializer circuitry 205 determines there is another queue status full flag to set (e.g., Block 830 returns a result of YES), the example initializer circuitry 205 returns to Block 820 to set the flag of a different consumer circuitry instance 115B. If the example initializer circuitry 205 determines there is not another queue status flag to set for the consumer circuitry 115 instances (e.g., Block 830 returns a result of NO), the example process 660 of FIG. 8 terminates and the example process of 600 of FIG. 6 terminates.

FIG. 9 is a flowchart representative of machine-readable instructions which may be executed to implement the example enqueue circuitry of FIG. 2. The example program 900 of FIG. 9 begins when the example enqueue circuitry 210 receives an attempt to enqueue a value into a queue. (Block 905). In examples where the example atomic queue circuitry 110 includes multiple circular queues of different priorities, the example enqueue circuitry 210 also determines whether to enqueue a value into a particular queue in block 905.

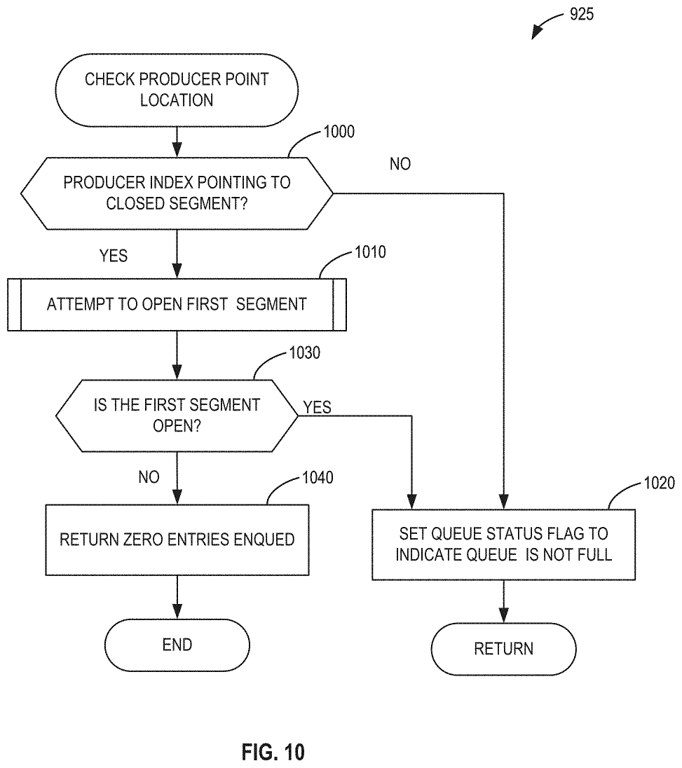

The example enqueue circuitry 210 determines whether the queue status flag of the producer circuitry instance 105A that generated the enqueue attempt indicates the queue is not full. (Block 910). If the example enqueue circuitry 210 determines the queue status flag indicates the queue is not full (e.g., Block 910 returns a result of YES), the example enqueue circuitry 210 updates the example producer index 315 using an atomic function. (Block 920). The example status circuitry 335 checks the producer index point location (Block 925). An example approach to check the producer index point location to correspond to the example implementation of the example enqueue circuitry 210 is disclosed further detail in connection with FIG. 10. The example enqueue circuitry 210 adds the value to the element identified by the producer index using an atomic function. (Block 930). The example enqueue circuitry 210 determines whether the written data has valid entries. (Block 935).

If the example enqueue circuitry 210 determines the written data has no valid entries. (e.g., Block 935 returns a result of NO), the example enqueue circuitry 210 sets the dummy flags in the entries to indicate a dummy entry. (Block 940). The producer continues to Block 960. If the example enqueue circuitry 210 determines the written data has valid entries (e.g., Block 935 returns a result of YES), the example enqueue circuitry 210 sets the dummy flag in the element to indicate the value is not a dummy value. (Block 945). The example enqueue circuitry 210 sets the ready flags in the entries to indicate the entries are ready. (Block 960). The example enqueue circuitry 210 returns the number of entries enqueued. (Block 965). The example process 900 of FIG. 9 terminates.

If the example enqueue circuitry 210 determines the queue status flag indicates the queue is full (e.g., Block 910 returns a result of NO), the example enqueue circuitry 210 attempts to open the first segment, wherein the first segment is indicated to be closed. (Block 1110). An example approach to open the first segment to correspond to the example implementation of the example enqueue circuitry 210 is disclosed further detail in connection with FIG. 11. The example enqueue circuitry 210 determines whether the first segment has been opened. (Block 915). If the example enqueue circuitry 210 determines the first segment has been opened (e.g., Block 915 returns a result of YES), the example enqueue circuitry 210 continues to Block 920. If the example enqueue circuitry 210 determines the first segment has not been opened (e.g., Block 915 returns a result of NO), the example enqueue circuitry 210 returns zero entries have been enqueued and the example process 900 of FIG. 9 terminates. (Block 917).

FIG. 10 is a flowchart representative of machine-readable instruction which may be executed to check a producer point location as described in FIG. 9. The example program 925 begins when the example status circuitry 335 determines whether the producer index point location points to the closed segment (Block 1000). If the example status circuitry 335 determines the producer index 315 does not identify an element in the closed segment (e.g., Block 1000 returns a result of NO), the example status circuitry 335 sets the queue status flag to indicate not full. (Block 1020). The example process 925 then terminates, and control returns to Block 930 of FIG. 9.

If the example status circuitry 335 determines the producer index point location points to the closed segment (e.g., Block 1000 returns a result of YES), the example status circuitry 335 attempts to open the first segment that is indicated to be closed. (Block 1010). An example approach to open the first segment to correspond to the example implementation of the example status circuitry 335 is disclosed in further detail in connection with FIG. 11. The example status circuitry 335 determines whether the first segment has been opened. (Block 1030). If the example status circuitry 335 determines the first segment has been opened (e.g., Block 1030 returns a result of YES), the process continues to Block 1020. If the example status circuitry 335 determines the first segment has not been opened (e.g., Block 1030 returns a result of NO), the producer returns zero entries have been enqueued. (Block 1040). The example process 925 then terminates.

FIG. 11 is a flowchart representative of machine-readable instruction which may be executed to attempt to open a segment as described in FIG. 8 and FIG. 9. The example process 1110 begins when the example status circuitry 335 takes a mutex lock. (Block 1105). The example status circuitry 335 determines whether an example first segment has opened (Block 1110). If the example status circuitry 335 determines the first segment has opened (e.g., Block 1110 returns a result of YES), the example status circuitry 335 returns the status that indicates the first segment has opened to one of Block 915 of FIG. 9, Block 1030 of FIG. 10, or Block 1270 of FIG. 12, based on which function originated the process 912, and the example process 912 terminates. If the example status circuitry 335 determines the first segment has not opened (e.g., Block 1110 returns a result of NO), the example status circuitry 335 determines whether a segment counter of an example second segment is at the maximum value (e.g., number of entries in the second segment). (Block 1120).

If the example status circuitry 335 determines the segment counter of the example second segment is not at the maximum value (e.g., Block 1120 returns a result of NO), the example status circuitry 335 returns the status that indicates the example first segment has not opened to one of Block 915 of FIG. 9, Block 1030 of FIG. 10, or Block 1270 of FIG. 12, based on which function originated the process 912, and the example process 912 terminates.

If the example status circuitry 335 determines the segment counter of the example second segment is at the maximum value (e.g., Block 1120 returns a result of YES), the example status circuitry 335 sets the closed-segment indicator to the second segment, which opens the example first segment and closes the example second segment. (Block 1130). The example status circuitry 335 sets the segment counter of the second segment to zero. (Block 1140). The example status circuitry 335 releases the mutex lock. (Block 1150). The example status circuitry 335 returns the status that indicates the first segment has opened to Block 915 of FIG. 9, Block 1030 of FIG. 10, or Block 1270 of FIG. 12, based on which function originated the process 912, and the example process 912 terminates.

FIG. 12 is a flowchart representative of machine-readable instruction which may be executed to implement the example dequeue circuitry of FIG. 2. The example process 1200 of FIG. 12 begins when the example dequeue circuitry 215 receives a request to dequeue a value from a consumer circuitry instance 115A. (Block 1210). The example dequeue circuitry 215 determines whether the queue status full flag of consumer circuitry instance 115A indicates the queue was not full at the time of the last update. (Block 1220). If the example dequeue circuitry 215 determines the queue status full flag indicates the queue is not full (e.g., Block 1220 returns a result of YES), the example dequeue circuitry removes the element identified by the consumer index 320. (Block 1230). The example dequeue circuitry 215 determines whether the producer index is less than the consumer index. (Block 1240). If the example dequeue circuitry 215 determines the producer index is not less than the consumer index (e.g., Block 1240 returns a result of NO), the producer reads the entries array. (Block 1260). An example approach to read the entries to correspond to the example implementation of the example dequeue circuitry 215 is disclosed in further detail in connection with FIG. 9. The example process 800 of FIG. 8 terminates.

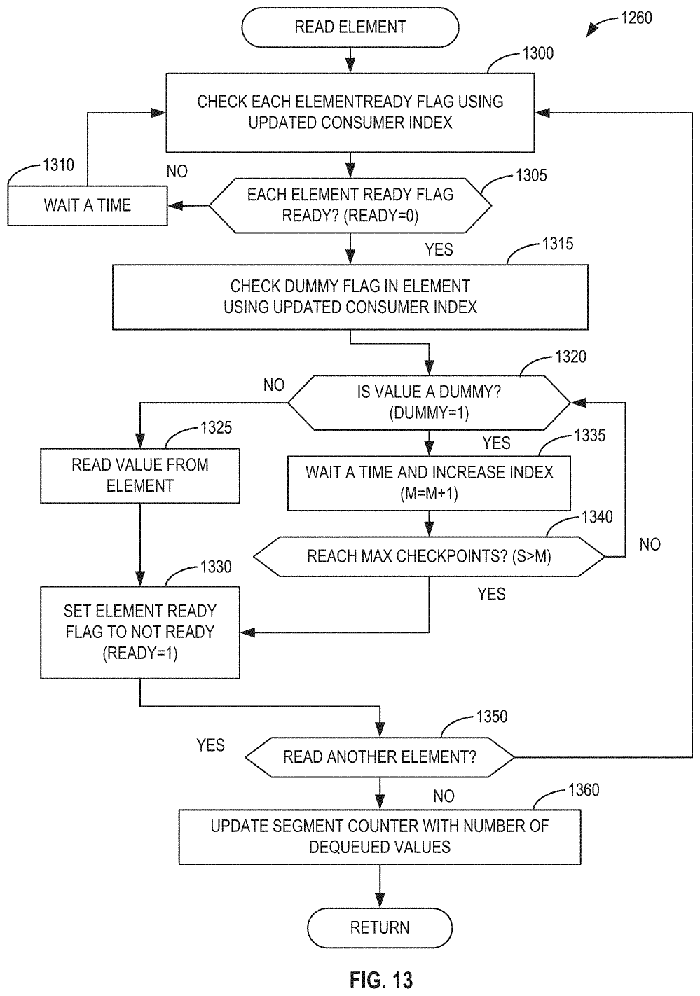

If the example dequeue circuitry 215 determines the queue status full flag indicates full (e.g., Block 1220 returns a result of NO), the example dequeue circuitry 215 attempts to open the first segment. (Block 610). An example approach to open the first segment to correspond to the example implementation of the example dequeue circuitry 215 is disclosed further detail in connection with FIG. 13 If the example dequeue circuitry 215 determines the first segment has been opened (e.g., Block 1270 returns a result of YES), the example dequeue circuitry 215 returns to Block 1230. If the example dequeue circuitry 215 determines the first segment has not been opened (e.g., Block 1270 returns a result of NO), the example dequeue circuitry 215 returns that the queue is empty and the example process 1200 of FIG. 12 terminates. (Block 1280).

If the example dequeue circuitry 215 determines the producer index is less than the consumer index (e.g., Block 1240 returns a result of YES), the example dequeue circuitry 215 sends an attempt to enqueue a dummy value to the example enqueue circuitry 210. (Block 1250). An attempt enqueue any value, real or dummy, is described in FIG. 9. The example dequeue circuitry 215 continues to Block 1260.

FIG. 13 is a flowchart representative of machine-readable instruction which may be executed to read an entries array as described by FIG. 12. The example process 1260 begins when the example dequeue circuitry 215 checks the ready flag 310B of the element identified by the updated consumer index 320. (Block 1300). The example dequeue circuitry 215 determines whether the ready flag 310B indicates the entry is ready. (Block 1305). If the example dequeue circuitry 215 determines the ready flag 310B indicates the element is ready (e.g., Block 1305 returns a result of YES), the example dequeue circuitry 215 checks the dummy flag of the element identified by the updated consumer index 320. (Block 1315). The example dequeue circuitry 215 determines whether the dummy flag 310C indicates the element has a dummy value. (Block 1320). If the example dequeue circuitry 215 determines the dummy flag 310C indicates the element has a dummy value (e.g., Block 1320 returns a result of NO), the example dequeue circuitry 215 reads out the data in the entry. (Block 1325). The example dequeue circuitry 215 sets the ready flag 310B to indicate the entry is not ready. (Block 1330). The example dequeue circuitry 215 determines whether there is another element to read. (Block 1350). If the example dequeue circuitry 215 determines there is another value to read (e.g., Block 1350 returns a result of YES), the example dequeue circuitry 215 returns to Block 130. If the example dequeue circuitry 215 determines there is not another entry to read (e.g., Block 1350 returns a result of NO), the example dequeue circuitry 215 updates the segment counter of the first segment based on the number of entries that has been dequeued. (Block 1360). The example process 1260 then terminates.

If the example dequeue circuitry 215 determines the ready flag 310B indicates the entry is not ready (e.g., Block 1305 returns a result of NO), the example dequeue circuitry 215 waits a first predetermined time before returning to Block 1300. (Block 1310).

If the example dequeue circuitry 215 determines the dummy flag 310C indicates the element has a dummy value (e.g., Block 1320 returns a result of YES), the example dequeue circuitry 215 increases an index by one and waits a second predetermined time before continuing to Block 1340. (Block 1335). The example dequeue circuitry 215 determines whether the index has reached the maximum checkpoints. (Block 1340). If the example dequeue circuitry 215 determines the index has not reached the maximum checkpoints (e.g., Block 1340 returns a result of NO), the example dequeue circuitry 215 continues to Block 1330.

FIG. 14 is a block diagram of an example processor platform 1400 structured to execute and/or instantiate the machine readable instructions and/or operations of FIGS. 6, 7, 8, 9, 10, 11, 12, and 13 to implement the example atomic queue circuitry 110 of FIG. 1. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements example initializer circuitry 205, example enqueue circuitry 210, example dequeue circuitry 215, and example status circuitry 335.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1432, which may be implemented by the machine readable instructions of FIGS. 6, 7, 8, 9, 10, 11, 12, and 13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowchart of FIGS. 6, 7, 8, 9, 10, 11, 12, and 13.

The cores 1502 may communicate by an example bus 1504. In some examples, the bus 1504 may implement a communication bus to effectuate communication associated with one(s) of the cores 1502. For example, the bus 1504 may implement at least one of an Inter-Integrated Circuit (I2C) bus, a Serial Peripheral Interface (SPI) bus, a PCI bus, or a PCIe bus. Additionally or alternatively, the bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and an example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The bus 1520 may implement at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 6, 7, 8, 9, 10, 11, 12, and 13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 6, 7, 8, 9, 10, 11, 12, and 13. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 6, 7, 8, 9, 10, 11, 12, and 13 As such, the FPGA circuitry 1600 may be structured to effectively instantiate some or all of the machine readable instructions of the flowcharts of FIGS. 6, 7, 8, 9, 10, 11, 12, and 13 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 6, 7, 8, 9, 10, 11, 12, and 13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions of FIGS. 6, 7, 8, 9, 10, 11, 12, and 13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 6, 7, 8, 9, 10, 11, 12, and 13 may be executed by one or more of the cores 1502 of FIG. 15 and a second portion of the machine readable instructions represented by the flowcharts of FIGS. 6, 7, 8, 9, 10, 11, 12, and 13 may be executed by the FPGA circuitry 1600 of FIG. 16.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

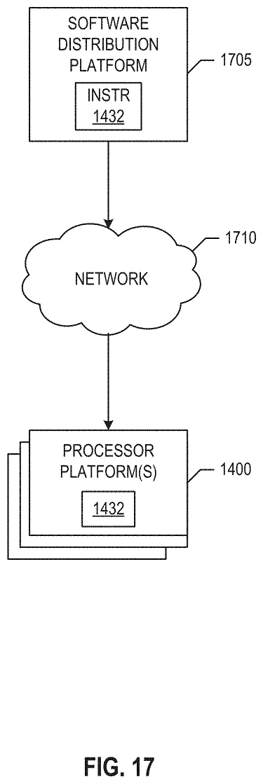

A block diagram illustrating an example software distribution platform 1705 to distribute software such as the example machine readable instructions 1432 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions of FIGS. 6, 7, 8, 9, 10, 11, 12, and 13, as described above. The one or more servers of the example software distribution platform 1705 are in communication with a network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions of FIGS. 6, 7, 8, 9, 10, 11, 12, and 13, may be downloaded to the example processor platform 1400, which is to execute the machine readable instructions 1432 to implement the atomic queue structure. In some example, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

From the foregoing, it will be appreciated that example systems, methods, apparatus, and articles of manufacture have been disclosed that improve the performance scaling of multi-producer multi-consumer queues. The disclosed systems, methods, apparatus, and articles of manufacture improve the efficiency of using a computing device by reducing or removing the dependency of locks in scalable multi-producer multi-consumer queues. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for scalable multi-producer multi-consumer queues are disclosed herein. Further examples and combinations thereof include the following.

Example 1 includes an apparatus for scalable multi-producer multi-consumer queues comprising an interface, and processor circuitry including one or more of at least one of a central processing unit, a graphic processing unit or a digital signal processor, the at least one of the central processing unit, the graphic processing unit or the digital signal processor having control circuitry, arithmetic and logic circuitry, and one or more registers, a Field Programmable Gate Array (FPGA), the FPGA including logic gate circuitry, a plurality of configurable interconnections, and storage circuitry, or Application Specific Integrate Circuitry (ASIC) including logic gate circuitry, the processor circuitry to instantiate enqueue circuitry to enqueue a first value into a first element of a queue using an atomic operation, the first element identified by a producer index, and update the producer index to identify a second element of the queue using an atomic operation, the second element determined by one or more of the producer index and a length of the queue, and dequeue circuitry to dequeue a second value from a third element of the queue using an atomic operation, the second element identified by a consumer index, and update the consumer index to identify a fourth element of the queue using an atomic operation, the fourth element determined by one or more of the consumer index and the length of the queue.

Example 2 includes the apparatus of example 1, wherein the enqueue circuitry is to further access the first value from producer circuitry, the first value to be a real value.

Example 3 includes the apparatus of example 1, wherein the enqueue circuitry is to further access the first value from consumer circuitry, the first value to be a dummy value generated by the consumer circuitry in response to a determination that consumer index and the producer index identify a same element.

Example 4 includes the apparatus of example 1, wherein the enqueue circuitry is to further access the first value from a first source and to access a third value from a second source, the first value to be enqueued into elements of the queue in a first process, the third value to be enqueued into the elements in a second process, the producer index to be updated in both the first process and the second process, the first process and the second process to execute independently of one another.

Example 5 includes the apparatus of example 1, wherein the dequeue circuitry is to further access a request for the second value from a first consumer circuitry instance and access a request for a third value from a second consumer circuitry instance, the second value to be dequeued from elements of the queue in a first process, the third value to be dequeued from the elements in a second process, the consumer index to be updated in both the first process and the second process, the first process and the second process to execute independently of one another.

Example 6 includes the apparatus of example 1, wherein the atomic operation used to enqueue the first value is one of atomic addition, atomic subtraction, atomic increment, or atomic decrement, the atomic operation used to update the consumer index is one of atomic addition, atomic subtraction, atomic increment, or atomic decrement, the atomic operation used to dequeue the second value is one of atomic addition, atomic subtraction, atomic increment, or atomic decrement, and the atomic operation used to update the consumer index is one of atomic addition, atomic subtraction, atomic increment, or atomic decrement.

Example 7 includes the apparatus of example 1, wherein the queue is a circular queue, wherein elements of the circular queue are divided into a first segment and a second segment, the division based on indices of the elements.

Example 8 includes the apparatus of example 7, further including status circuitry to switch the first segment between a closed state and an open state, the status circuitry to further switch the second segment between the closed state and the open state, the state of the first segment to be different from the state of the second segment.

Example 9 includes the apparatus of example 8, wherein the status circuitry is further to switch the first segment to the closed state and switch the second segment to the open state, the status circuitry to perform the switching in response to a determination that a number of elements without a value in the first segment equals a number of elements in the first segment.

Example 10 includes the apparatus of example 9, wherein the status circuitry is to further limit a source of the first value to one enqueue operation within the first segment while the first segment is in the closed state.

Example 11 includes the apparatus of example 1, wherein the queue is a first circular queue having a first priority, further including a second circular queue having a second priority, the enqueue circuitry to further determine whether to enqueue the first value into the first circular queue or the second circular queue based on an assigned priority of the first value.

Example 12 includes at least one non-transitory machine-readable medium comprising instructions that, when executed, cause at least one processor to at least enqueue a first value into a first element of a queue using an atomic operation, the first element identified by a producer index, update the producer index to identify a second element of the queue using an atomic operation, the second element determined by one or more of the producer index and a length of the queue, dequeue a second value from a third element of the queue using an atomic operation, the second element identified by a consumer index, and update the consumer index to identify a fourth element of the queue in the using an atomic operation, the fourth element determined by one or more of the consumer index and the length of the queue.

Example 13 includes the at least one non-transitory machine-readable medium of example 12, wherein the instructions, when executed, cause the at least one processor to access the first value from producer circuitry, the first value to be a real value.

Example 14 includes the at least one non-transitory machine-readable medium of example 12, wherein the instructions, when executed, cause the at least one processor to access the first value from consumer circuitry, the first value to be a dummy value generated by the consumer circuitry in response to a determination that consumer index and the producer index identify a same element.

Example 15 includes the at least one non-transitory machine-readable medium of example 12, wherein the instructions, when executed, cause the at least one processor to receive the first value from a first source and receive a third value from a second source, the first value to be enqueued into elements of the queue in a first process, the third value to be enqueued into the elements in a second process, the producer index to be updated in both the first process and the second process, the first process and the second process to execute independently of one another.

Example 16 includes the at least one non-transitory machine-readable medium of example 12, wherein the instructions, when executed, cause the at least one processor to receive a request for the second value from a first consumer circuitry instance and receive a request for a third value from a second consumer circuitry instance, the second value to be dequeued from elements of the queue in a first process, the third value to be dequeued from the elements in a second process, the consumer index to be updated in both the first process and the second process, the first process and the second process to execute independently of one another.

Example 17 includes the at least one non-transitory machine-readable medium of example 12, wherein the atomic operation used to enqueue the first value is one of atomic addition, atomic subtraction, atomic increment, or atomic decrement, the atomic operation used to update the consumer index is one of atomic addition, atomic subtraction, atomic increment, or atomic decrement, the atomic operation used to dequeue the second value is one of atomic addition, atomic subtraction, atomic increment, or atomic decrement, and the atomic operation used to update the consumer index is one of atomic addition, atomic subtraction, atomic increment, or atomic decrement.

Example 18 includes the at least one non-transitory machine-readable medium of example 12, wherein the queue is a circular queue, wherein the instructions, when executed, cause the at least one processor to divide elements of the circular queue into a first segment and a second segment, the division based on indices of the elements.

Example 19 includes the at least one non-transitory machine-readable medium of example 18, wherein the instructions, when executed, cause the at least one processor to switch the first segment between a closed state and an open state and further to switch the second segment between the closed state and the open state, the state of the first segment to be different from the state of the second segment.

Example 20 includes the at least one non-transitory machine-readable medium of example 19, wherein the instructions, when executed, cause the at least one processor to switch the first segment to the closed state and switch the second segment to the open state, the switches in response to a determination that a number of elements without a value in the first segment equals a number of elements in the first segment.

Example 21 includes the at least one non-transitory machine-readable medium of example 20, wherein the instructions, when executed, cause the at least one processor to limit a source of the first value to one enqueue within the first segment while the first segment is in the closed state.

Example 22 includes the at least one non-transitory machine-readable medium of example 12, wherein the queue is a first circular queue having a first priority, further including a second circular queue having a second priority, and the instructions, when executed, cause the at least one processor to further determine whether to enqueue the first value into the first circular queue or the second circular queue based on an assigned priority of the first value.

Example 23 includes a method for scalable mutli-producer multi-consumer queues, the method comprising enqueuing a first value into a first element of a queue using an atomic operation, the first element identified by a producer index, updating the producer index to identify a second element of the queue using an atomic operation, the second element determined by one or more of the producer index and a length of the queue, dequeuing a second value from a third element of the queue using an atomic operation, the second element identified by a consumer index, and updating the consumer index to identify a fourth element of the queue using an atomic operation, the fourth element determined by one or more of the consumer index and the length of the queue.

Example 24 includes the method of example 23, further including accessing the first value from producer circuitry, the first value to be a real value.

Example 25 includes the method of example 23, further including accessing the first value from consumer circuitry, the first value to be a dummy value generated by the consumer circuitry in response to a determination that consumer index and the producer index identify a same element.

Example 26 includes the method of example 23, further including receiving the first value from a first source and receiving a third value from a second source, enqueuing the first value into elements of the queue in a first process and enqueuing the third value into the elements in a second process, updating the producer index in both the first process and the second process, and executing the first process and the second process independently of one another.

Example 27 includes the method of example 23, further including receiving a request for the second value from a first consumer circuitry instance and receiving a request for a third value from a second consumer circuitry instance, dequeuing the first value from elements of the queue in a first process and dequeuing the third value from the elements in a second process, updating the consumer index in both the first process and the second process, and executing the first process and the second process independently of one another.

Example 28 includes the method of example 23, wherein the atomic operation used to enqueue the first value is one of atomic addition, atomic subtraction, atomic increment, or atomic decrement, the atomic operation used to update the consumer index is one of atomic addition, atomic subtraction, atomic increment, or atomic decrement, the atomic operation used to dequeue the second value is one of atomic addition, atomic subtraction, atomic increment, or atomic decrement, and the atomic operation used to update the consumer index is one of atomic addition, atomic subtraction, atomic increment, or atomic decrement.

Example 29 includes the method of example 23, wherein the queue is a circular queue, further including dividing elements of the circular queue into a first segment and a second segment, the division based on indices of the elements.

Example 30 includes the method of example 29, further including switching the first segment between a closed state and an open state and switching the second segment between the closed state and the open state, the state of the first segment to be different from the state of the second segment.

Example 31 includes the method of example 30, further including switching the first segment to the closed state and switching the second segment to the open state, the switches in response to determining that a number of elements without a value in the first segment equals a number of elements in the first segment.

Example 32 includes the method of example 31, further including limiting a source of the first value to one enqueue within the first segment while the first segment is in the closed state.

Example 33 includes the method of example 23, wherein the queue is a first circular queue having a first priority, further including a second circular queue having a second priority, and further including determining whether to enqueue the first value into the first circular queue or the second circular queue based on an assigned priority of the first value.

Example 34 includes an apparatus for scalable mutli-producer multi-consumer queues comprising means for enqueuing to enqueue a first value into a first element of a queue using an atomic operation, the first element identified by a producer index, and update the producer index to identify a second element of the queue using an atomic operation, the second element determined by one or more of the producer index and a length of the queue, and means for dequeuing to dequeue a second value from a third element of the queue using an atomic operation, the second element identified by a consumer index, and update the consumer index to identify a fourth element of the queue using an atomic operation, the fourth element determined by one or more of the consumer index and the length of the queue.

Example 35 includes the apparatus of example 34, wherein the means for enqueuing is to further receive the first value from producer circuitry, the first value to be a real value.

Example 36 includes the apparatus of example 34, wherein the means for enqueuing is to further receive the first value from consumer circuitry, the first value to be a dummy value generated by the consumer circuitry in response to a determination that the consumer index and the producer index identify a same element.

Example 37 includes the apparatus of example 34, wherein the means for enqueueing is further to receive the first value from a first source and receive a third value from a second source, enqueue the first value into elements of the queue in a first process and enqueue the third value into the elements in a second process, update the producer index in both the first process and the second process, and execute the first process and the second process independently of one another.

Example 38 includes the apparatus of example 34, wherein the means for dequeuing is further to receive a request for the second value from a first consumer circuitry instance and receive a request for a third value from a second consumer circuitry instance, dequeue the first value from elements of the queue in a first process and dequeue the third value from the elements in a second process, update the consumer index in both the first process and the second process, and execute the first process and the second process independently of one another.

Example 39 includes the apparatus of example 34, wherein the atomic operation used to enqueue the first value is one of atomic addition, atomic subtraction, atomic increment, or atomic decrement, the atomic operation used to update the consumer index is one of atomic addition, atomic subtraction, atomic increment, or atomic decrement, the atomic operation used to dequeue the second value is one of atomic addition, atomic subtraction, atomic increment, or atomic decrement, and the atomic operation used to update the consumer index is one of atomic addition, atomic subtraction, atomic increment, or atomic decrement.

Example 40 includes the apparatus of example 34, wherein the queue is a circular queue, further including means for dividing elements of the circular queue into a first segment and a second segment, the division based on indices of the elements.

Example 41 includes the apparatus of example 40, further including means for switching the first segment between a closed state and an open state, the means for switching to switch the second segment between the closed state and the open state, the state of the first segment to be different from the state of the second segment.

Example 42 includes the apparatus of example 41, wherein the means for switching is further to, in response to determining that a number of elements without a value in the first segment equals a number of elements in the first segment switch the first segment to the closed state, and switch the second segment to the open state.

Example 43 includes the apparatus of example 42, further including means for limiting a source of the first value to one enqueue operation within the first segment while the first segment is in the closed state.

Example 44 includes the apparatus of example 34, wherein the queue is a first circular queue having a first priority, further including a second circular queue having a second priority, and further including means for determining whether to enqueue the first value into the first circular queue or the second circular queue based on an assigned priority of the first value.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus for scalable multi-producer multi-consumer queues comprising:
an interface; and
processor circuitry including one or more of:
at least one of a central processing unit, a graphic processing unit or a digital signal processor, the at least one of the central processing unit, the graphic processing unit or the digital signal processor having control circuitry, arithmetic and logic circuitry, and one or more registers;
a Field Programmable Gate Array (FPGA), the FPGA including logic gate circuitry, a plurality of configurable interconnections, and storage circuitry; or
Application Specific Integrate Circuitry (ASIC) including logic gate circuitry;
the processor circuitry to instantiate:
enqueue circuitry to:
enqueue a first value into a first element of a queue using an atomic operation, the first element identified by a producer index; and
update the producer index to identify a second element of the queue using an atomic operation, the second element determined by one or more of the producer index and a length of the queue; and
dequeue circuitry to:
dequeue a second value from a third element of the queue using an atomic operation, the second element identified by a consumer index; and
update the consumer index to identify a fourth element of the queue using an atomic operation, the fourth element determined by one or more of the consumer index and the length of the queue.

2. The apparatus of claim 1, wherein the enqueue circuitry is to further access the first value from producer circuitry, the first value to be a real value.

3. The apparatus of claim 1, wherein the enqueue circuitry is to further access the first value from consumer circuitry, the first value to be a dummy value generated by the consumer circuitry in response to a determination that consumer index and the producer index identify a same element.

4. The apparatus of claim 1, wherein the enqueue circuitry is to further access the first value from a first source and to access a third value from a second source, the first value to be enqueued into elements of the queue in a first process, the third value to be enqueued into the elements in a second process, the producer index to be updated in both the first process and the second process, the first process and the second process to execute independently of one another.

5. The apparatus of claim 1, wherein the dequeue circuitry is to further access a request for the second value from a first consumer circuitry instance and access a request for a third value from a second consumer circuitry instance, the second value to be dequeued from elements of the queue in a first process, the third value to be dequeued from the elements in a second process, the consumer index to be updated in both the first process and the second process, the first process and the second process to execute independently of one another.

6. The apparatus of claim 1, wherein:
the atomic operation used to enqueue the first value is one of atomic addition, atomic subtraction, atomic increment, or atomic decrement;
the atomic operation used to update the consumer index is one of atomic addition, atomic subtraction, atomic increment, or atomic decrement;
the atomic operation used to dequeue the second value is one of atomic addition, atomic subtraction, atomic increment, or atomic decrement; and
the atomic operation used to update the consumer index is one of atomic addition, atomic subtraction, atomic increment, or atomic decrement.

7. The apparatus of claim 1, wherein the queue is a circular queue, wherein elements of the circular queue are divided into a first segment and a second segment, the division based on indices of the elements.

8. The apparatus of claim 7, further including status circuitry to switch the first segment between a closed state and an open state, the status circuitry to further switch the second segment between the closed state and the open state, the state of the first segment to be different from the state of the second segment.

9. The apparatus of claim 8, wherein the status circuitry is further to switch the first segment to the closed state and switch the second segment to the open state, the status circuitry to perform the switching in response to a determination that a number of elements without a value in the first segment equals a number of elements in the first segment.

10. The apparatus of claim 9, wherein the status circuitry is to further limit a source of the first value to one enqueue operation within the first segment while the first segment is in the closed state.

11. The apparatus of claim 1, wherein the queue is a first circular queue having a first priority, further including a second circular queue having a second priority, the enqueue circuitry to further determine whether to enqueue the first value into the first circular queue or the second circular queue based on an assigned priority of the first value.

12. At least one non-transitory machine-readable medium comprising instructions that, when executed, cause at least one processor to at least:
enqueue a first value into a first element of a queue using an atomic operation, the first element identified by a producer index;
update the producer index to identify a second element of the queue using an atomic operation, the second element determined by one or more of the producer index and a length of the queue;
dequeue a second value from a third element of the queue using an atomic operation, the second element identified by a consumer index; and
update the consumer index to identify a fourth element of the queue in the using an atomic operation, the fourth element determined by one or more of the consumer index and the length of the queue.

13. The at least one non-transitory machine-readable medium of claim 12, wherein the instructions, when executed, cause the at least one processor to access the first value from producer circuitry, the first value to be a real value.

14. The at least one non-transitory machine-readable medium of claim 12, wherein the instructions, when executed, cause the at least one processor to access the first value from consumer circuitry; the first value to be a dummy value generated by the consumer circuitry in response to a determination that consumer index and the producer index identify a same element.

15. The at least one non-transitory machine-readable medium of claim 12, wherein the instructions, when executed, cause the at least one processor to receive the first value from a first source and receive a third value from a second source, the first value to be enqueued into elements of the queue in a first process, the third value to be enqueued into the elements in a second process, the producer index to be updated in both the first process and the second process, the first process and the second process to execute independently of one another.

16. The at least one non-transitory machine-readable medium of claim 12, wherein the instructions, when executed, cause the at least one processor to receive a request for the second value from a first consumer circuitry instance and receive a request for a third value from a second consumer circuitry instance, the second value to be dequeued from elements of the queue in a first process, the third value to be dequeued from the elements in a second process, the consumer index to be updated in both the first process and the second process, the first process and the second process to execute independently of one another.

17. The at least one non-transitory machine-readable medium of claim 12, wherein:
the atomic operation used to enqueue the first value is one of atomic addition, atomic subtraction, atomic increment, or atomic decrement;
the atomic operation used to update the consumer index is one of atomic addition, atomic subtraction, atomic increment, or atomic decrement;
the atomic operation used to dequeue the second value is one of atomic addition, atomic subtraction, atomic increment, or atomic decrement; and
the atomic operation used to update the consumer index is one of atomic addition, atomic subtraction, atomic increment, or atomic decrement.

18. The at least one non-transitory machine-readable medium of claim 12, wherein the queue is a circular queue, wherein the instructions, when executed, cause the at least one processor to divide elements of the circular queue into a first segment and a second segment, the division based on indices of the elements.

19. The at least one non-transitory machine-readable medium of claim 18, wherein the instructions, when executed, cause the at least one processor to switch the first segment between a closed state and an open state and further to switch the second segment between the closed state and the open state, the state of the first segment to be different from the state of the second segment.

20. The at least one non-transitory machine-readable medium of claim 19, wherein the instructions, when executed, cause the at least one processor to switch the first segment to the closed state and switch the second segment to the open state, the switches in response to a determination that a number of elements without a value in the first segment equals a number of elements in the first segment.

21. The at least one non-transitory machine-readable medium of claim 20, wherein the instructions, when executed, cause the at least one processor to limit a source of the first value to one enqueue within the first segment while the first segment is in the closed state.

22. The at least one non-transitory machine-readable medium of claim 12, wherein the queue is a first circular queue having a first priority, further including a second circular queue having a second priority, and the instructions, when executed, cause the at least one processor to further determine whether to enqueue the first value into the first circular queue or the second circular queue based on an assigned priority of the first value.

23. A method for scalable mutli-producer multi-consumer queues, the method comprising:
enqueuing a first value into a first element of a queue using an atomic operation, the first element identified by a producer index;
updating the producer index to identify a second element of the queue using an atomic operation, the second element determined by one or more of the producer index and a length of the queue;
dequeuing a second value from a third element of the queue using an atomic operation, the second element identified by a consumer index; and
updating the consumer index to identify a fourth element of the queue using an atomic operation, the fourth element determined by one or more of the consumer index and the length of the queue.

24. The method of claim 23, further including accessing the first value from producer circuitry, the first value to be a real value.

25-33. (canceled)

34. An apparatus for scalable mutli-producer multi-consumer queues comprising:
means for enqueuing to:
enqueue a first value into a first element of a queue using an atomic operation, the first element identified by a producer index; and
update the producer index to identify a second element of the queue using an atomic operation, the second element determined by one or more of the producer index and a length of the queue; and
means for dequeuing to:
dequeue a second value from a third element of the queue using an atomic operation, the second element identified by a consumer index; and
update the consumer index to identify a fourth element of the queue using an atomic operation, the fourth element determined by one or more of the consumer index and the length of the queue.

35-44. (canceled)
